(19) United States
(12) Patent Application Publication
(10) Pub. No.: US 2023/0304526 A1
(43) Pub. Date: Sep. 28, 2023

(54) SCREW FASTENING STRUCTURE AND DEVICE INCLUDING THE SAME

(71) Applicant: FUJIFILM Business Innovation Corp., Tokyo (JP)

(72) Inventors: Shogo FUJITA, Kanagawa (JP); Hayato INOUE, Kanagawa (JP)

(73) Assignee: FUJIFILM Business Innovation Corp., Tokyo (JP)

(21) Appl. No.: 17/894,168

(22) Filed: Aug. 24, 2022

(30) Foreign Application Priority Data
Mar. 23, 2022 (JP) 2022-046179

(51) Int. Cl. F16B 37/04

(52) U.S. Cl. CPC F16B 37/04

(57) ABSTRACT

The screw fastening structure includes a nut and a nut holding portion that holds the nut displaceably in at least one direction, which are provided on at least one of a first member and a second member screw-fastened to each other with a screw and the nut.

### CROSS-REFERENCE TO RELATED APPLICATIONS

This application is based on and claims priority under 35 USC 119 from Japanese Patent Application No. 2022-046179 filed Mar. 23, 2022.

### BACKGROUND

### (i) Technical Field

The present invention relates to a screw fastening structure and a device including the screw fastening structure.

### (ii) Related Art

JP2014-9698A (claim 1, FIGS. 2 to 3) describes an assembled structure including a female screw member formed from a metal plate material to form a female screw, an insertion hole member positioned in the female screw and having an insertion hole formed therein, and a male screw member that fixes the insertion hole member to the female screw member by being inserted through the insertion hole and screwing the insertion hole into the female screw.

Additionally, JP2014-9698A (claim 1, FIGS. 2 to 3) describes that, regarding the assembled structure, the female screw member has an overlapped plate portion in which a part of the metal plate material constituting the female screw member is folded in half and overlapped, and a tap drill hole that penetrates both the metal plate materials of the overlapped plate portion, the female screw is formed in the tap drill hole that penetrates through both the metal plate materials of the overlapped plate portion, and both the metal plate materials of the overlapped plate portion are brought into close contact with each other in a state in which the male screw member is tightened.

JP2014-177996A (claim 1, FIGS. 3 to 6) describes a fastening part structure having a bis having a bis head and a screw portion, a fastening material fastened by the bis, and a fastened material sandwiched between the bis and the fastening material and fastened to the fastening material, a bis hole of the fastening material to which the bis is screwed being formed by a substantially cylindrical extruded portion that protrudes in a bis insertion direction subjected to extrusion processing.

Additionally, JP2014-177996A (claim 1, FIGS. 3 to 6) describes that, regarding the fastening part structure, the substantially cylindrical extruded portion is a waveform extrusion in which the fastening material subjected to extrusion processing is folded in the circumferential direction and extends in the longitudinal direction of the cylindrical shape.

### SUMMARY

Aspects of non-limiting embodiments of the present disclosure relate to a screw fastening structure and a device including the screw fastening structure that can perform screw fastening without any trouble even in a case where there is a positional deviation between the nut and a screw through-hole of a first member or a second member on a side where the screw is inserted, in the screw fastening structure in which the nut is attached to at least one of the first member and the second member screw-fastened with the screw and the nut in advance.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a screw fastening structure including a nut and a nut holding portion that holds the nut displaceably in at least one direction, which are provided on at least one of a first member and a second member screw-fastened to each other with a screw and the nut.

### BRIEF DESCRIPTION OF THE DRAWINGS

Exemplary embodiment(s) of the present invention will be described in detail based on the following figures, wherein:

FIGS. 1A and 1B are views of a screw fastening structure according to Exemplary Embodiment 1, FIG. 1A is a front view of the screw fastening structure, and FIG. 1B is a partial cross-sectional view taken along line B-B of FIG. 1A;

FIG. 2 is an exploded view of the screw fastening structure of FIGS. 1A and 1B;

FIG. 3 is a perspective view showing a nut, a nut holding portion, and the like in the screw fastening structure of FIGS. 1A and 1B;

FIG. 4 is a perspective view showing a nut removed from the nut holding portion, the nut holding portion, and the like;

FIG. 5A is an explanatory diagram showing a partial cross section of the nut and the nut holding portion, and

FIG. 5B is a schematic cross-sectional view taken along line V-V of FIG. 3;

FIG. 6 is a partial cross-sectional view of a fastening process of the screw fastening structure;

FIGS. 7A and 7B are views of a screw fastening structure according to Exemplary Embodiment 2, FIG. 7A is a front view of the screw fastening structure, and FIG. 7B is a partial cross-sectional view taken along line B-B of FIG. 7A;

FIG. 8 is a perspective view showing a nut, a nut holding portion, and the like in the screw fastening structure of FIGS. 7A and 7B;

FIG. 9 is a perspective view showing a nut removed from the nut holding portion, the nut holding portion, and the like;

FIG. 10A is an explanatory diagram showing a partial cross section of the nut and the nut holding portion, and

FIG. 10B is a schematic cross-sectional view taken along line V-V of FIG. 3;

FIG. 11 is a schematic view of a device including a screw fastening structure according to Exemplary Embodiment 3;

FIG. 12A is a plan view of parts of Modification Example 1 of the screw fastening structure, and FIG. 12B is a plan view of parts of Modification Example 2 of the screw fastening structure;

FIG. 13A is a plan view of parts of Modification Example 3 of the screw fastening structure, and FIG. 13B is a schematic cross-sectional view taken along line B-B of FIG. 13A; and

FIG. 14 is a plan view of parts of Modification Example 4 of the screw fastening structure.

### DETAILED DESCRIPTION

Hereinafter, exemplary embodiments for carrying out the present invention will be described with reference to the accompanying drawings.

### Exemplary Embodiment 1

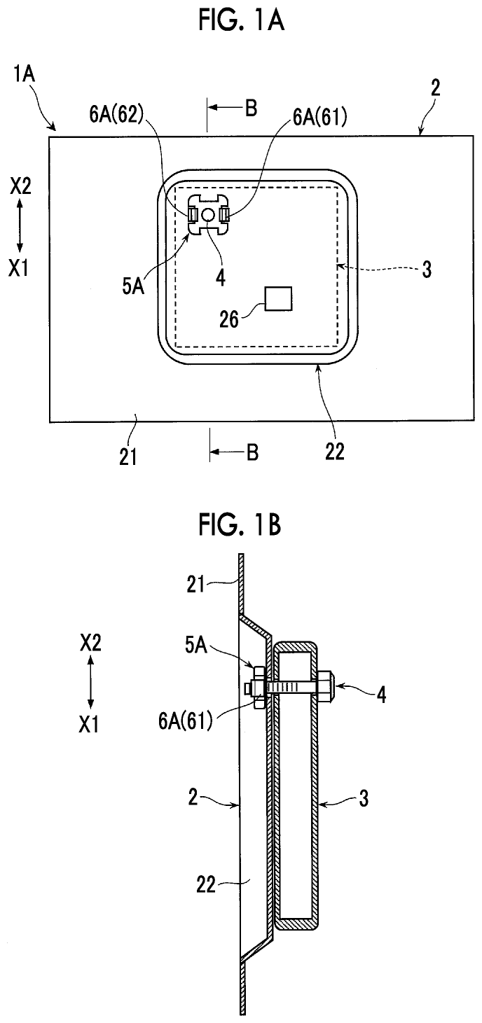

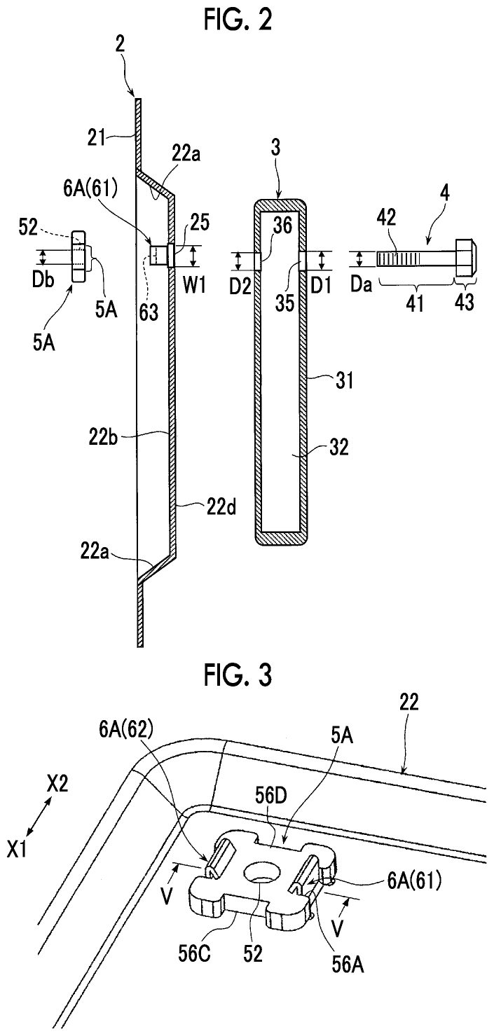

FIGS. 1A and 1B are a front view and a partial cross-sectional view showing a screw fastening structure 1A according to Exemplary Embodiment 1 of the present invention. FIG. 2 is an exploded view showing a partial cross section of the screw fastening structure 1A.

As shown in FIGS. 1A and 1B, FIG. 2, and the like, the screw fastening structure 1A is a structure in which a first member 2 and a second member 3 are screw-fastened with a screw 4 and a nut 5A.

Additionally, the screw fastening structure 1A includes the first member 2, the second member 3, the screw 4, the nut 5A, and a nut holding portion 6A.

The first member 2 is one member in a case where screw-fastened with the screw fastening structure 1A.

As shown in FIG. 2, the first member 2 in Exemplary Embodiment 1 is a plate-shaped member provided with a screw through-hole 25 through which the screw 4 is passed. Additionally, in Exemplary Embodiment 1, the first member 2 is used as a member on a side to which the nut 5A is attached in advance.

Specifically, as shown in FIGS. 1A and 1B and FIG. 2, the first member 2 is a member consisting of a plate-shaped body 21 and a recessed portion (in other words, a raised portion formed in a raised shape) 22 formed in a recessed shape in a part of the body 21 within a required range.

The recessed portion 22 is configured to attach the second member 3 to a surface portion 22d on a side where the recessed portion is recessed and becomes convex by screw fastening. Additionally, the recessed portion 22 is provided with the screw through-hole 25 at a required position.

Moreover, the first member 2 is configured by a metallic plate member (sheet metal), and is used as, for example, a support frame. Additionally, in the first member 2, the recessed portion 22 is configured as a thin-walled portion having a wall thickness smaller than the wall thickness of the body 21 (an example of the other portion). The wall thickness of the thin-walled portion is, for example, a portion consisting of such a small thickness that normally threading an extruded portion is difficult in a case where extrusion processing is performed. The wall thickness of the thin-walled portion varies depending on the type of metal, the area of the thin-walled portion, and the like, but is, for example, 0.4 mm or less.

The second member 3 is the other member in a case where the screw is screw-fastened by the screw fastening structure 1A.

As shown in FIG. 2, the second member 3 in Exemplary Embodiment 1 is a member provided with screw through-holes 35 and 36 through which the screw 4 is passed. Additionally, in Exemplary Embodiment 1, the second member 3 is used as a member on a side where the screw 4 is inserted toward the nut 5A in a case where screw fastening is performed.

Additionally, the second member 3 is configured by a metallic member. More specifically, as shown in FIGS. 1A and 1B and FIG. 2, the second member 3 is a member consisting of a body 31 having a structure having a space portion 32 inside. Additionally, in the second member 3, required components and the like (not shown) are disposed including the space portion 32.

The screw through-holes 35 and 36 in the second member 3 are provided so as to allow the screw 4 to pass through the space portion 32 of the second member 3.

Moreover, in a case where the second member 3 is screw-fastened to the recessed portion 22 of the first member 2, the second member 3 is screw-fastened after being kept positioned at a required attachment position in the recessed portion 22.

The screw 4 may be any screw part that can be screwed into a screw hole (female screw) 52 of the nut 5A, and includes not only one referred to as a screw but also one referred to as a bis, a bolt, or the like.

As shown in FIG. 2, the screw 4 in Exemplary Embodiment 1 is a screw part configured by a columnar body portion 41 in which a screw thread (male screw) 42 is formed in a required range, and a head portion 43 provided at an end part of the body portion 41.

The nut 5A is a nut having a screw hole 52 to which the screw 4 is screwed.

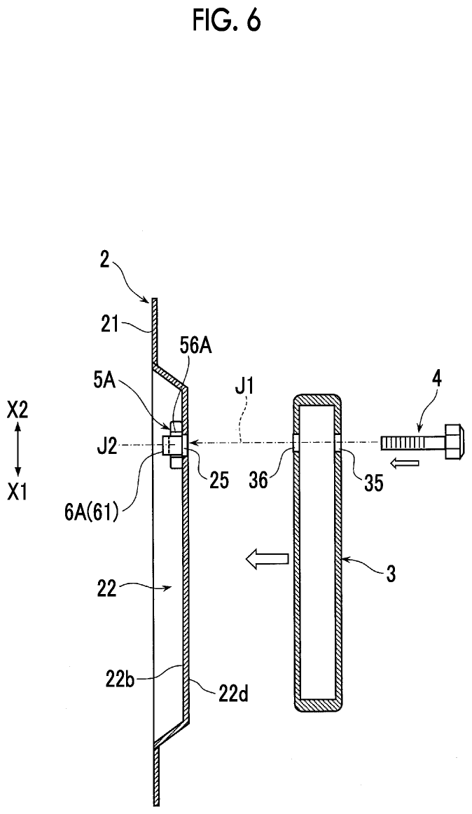

As shown in FIGS. 3 and 6, the nut 5A in Exemplary Embodiment 1 is used so as to be disposed in advance and attached to a screw fastening portion (a portion having the screw through-hole 25) of the first member 2.

Additionally, the nut 5A has a body 51 consisting of a substantially square shape with rounded corner portions as the planar shape thereof and a required thickness d in a stage before a recessed plane portion 56 described below is provided.

The nut holding portion 6A is a portion, which holds the nut 5A in a displaceable state in at least one direction, in the first member 2 in which the nut 5A is disposed.

As shown in FIGS. 1A and 1B and FIG. 3, the nut holding portion 6A in Exemplary Embodiment 1 is configured as a holding unit that holds the nut 5A so as to reciprocate and displace in one direction (X direction) indicated by an arrow X1 or X2.

Additionally, as shown in FIGS. 1A, 3 to 5, and the like, the nut holding portion 6A is configured by a pair of members 61 and 62 disposed so as to face each other across the nut 5A, on a surface portion 22b which is a bottom surface of the recessed portion 22 of the first member 2 on the recessed side.

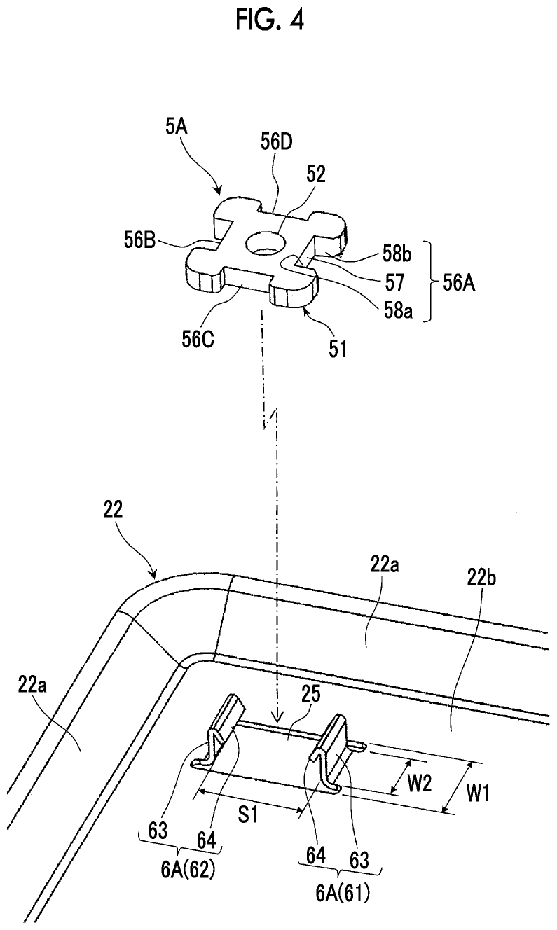

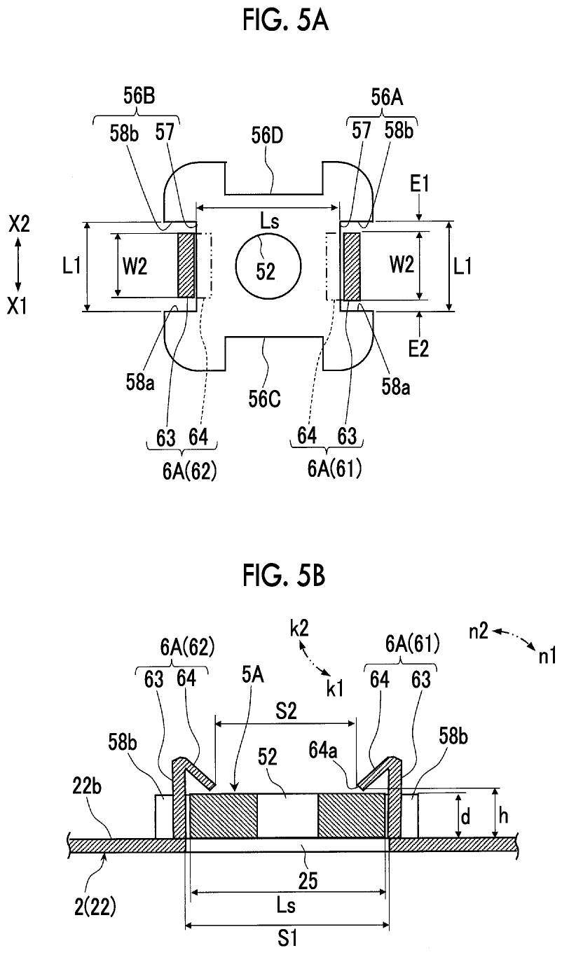

As shown in FIGS. 4, 5, and the like, the pair of members 61 and 62 is both formed as a member having a shape having a rising surface portion 63 that rises substantially vertically at the surface portion 22b of the recessed portion 22, and a bent surface portion 64 that is obliquely bent to sides facing each other and downward (to the screw through-hole 25) at a top portion of the rising surface portion 63.

Additionally, the nut holding portion 6A in Exemplary Embodiment 1 is configured as a member in which both the pair of members 61 and 62 can be elastically deformed.

Here, the expression “can be elastically deformed” means that the members 61 and 62 can be deformed by utilizing elasticity in a direction in which the members 61 and 62 do not interfere with the course of the nut 5A in a case where the nut 5A is attached so as to be held by the nut holding portion 6A and in a case where the nut 5A comes into contact with the members 61 and 62.

As shown in FIG. 5B, the pair of members 61 and 62 is temporarily elastically deformed such that the rising surface portions 63 warp in a direction n1 away from each other, and is temporarily elastically deformed so as to move in a direction k1 in which the bent surface portion 64 approaches the rising surface portion 63, or both the rising surface portion 63 and the bent surface portion 64 are temporarily elastically deformed as described above.

In this case, the rising surface portion 63 is elastically deformed and then moved and restored in a direction indicated by an arrow n2 by a restoring force, and the bent surface portion 64 is elastically deformed and then moved and restored in a direction indicated by the arrow k2 by a restoring force.

Moreover, as shown in FIG. 4, the nut holding portion 6A is configured as the members 61 and 62 formed by cutting out a portion (a part where the nut 5A is disposed) of the recessed portion 22 in the first member 2 in which the nut 5A is disposed.

In Exemplary Embodiment 1, the members 61 and 62 of the nut holding portion 6A are produced as follows, for example.

First, as shown in FIG. 4, two cut pieces are obtained by making two cuts parallel to a direction orthogonal to a direction indicated by an arrow X by cutting a part of the recessed portion 22 at a central part in the orthogonal direction. Subsequently, the two cut pieces are bent in a direction perpendicular to the surface portion 22b of the recessed portion 22 and in a direction opposite to the recessed direction, and then directing free ends of the cut pieces downwardly at a required angle toward mutually facing sides.

Accordingly, as shown in a lower portion of FIG. 4, the members 61 and 62 consisting of the rising surface portion 63 and the bent surface portion 64 are produced in the recessed portion 22. In a case where the members 61 and 62 of the nut holding portion 6A are produced in this way, the nut holding portion 6A may be provided on the first member 2 without requiring a unit for fixing the nut holding portion 6A to the first member 2, compared to a case where the nut holding portion 6A is not configured as a member formed by cutting out a part of the first member 2.

Additionally, the portion cut out in the recessed portion 22 in a case where the members 61 or 62 is produced becomes a hole consisting of a substantially rectangular shape that is long in the direction orthogonal to the direction indicated by the arrow X, and this hole is used as the screw through-hole 25. In this case, as shown in FIG. 4, the screw through-hole 25 has a rectangular shape consisting of a width W1 corresponding to a spacing between the two cuts.

Additionally, as shown in FIG. 4 or 5, the rising surface portion 63 of the member 61 or 62 rises with a width W2 (<W1) narrower than the width W1 of the screw through-hole 25 and are formed so as to face each other with a required spacing S1. Additionally, the bent surface portions 64 of the member 61 or 62 are formed such that a bent tip 64a of the bent surface portion 64 has a required height (gap) h from the surface portion 22b of the recessed portion 22. In this case, the height h of the bent tip 64a has a value slightly larger than a thickness d of the nut 5A (h>d).

The dimensions such as the width W1 of the screw through-hole 25, the width W2 of the rising surface portion 63 of the members 61 or 62, and the height h of the bent tip 64a of the bent surface portion 64 of the members 61 or 62 are adjusted and selected according to a relationship with the dimensions of the nut 5A and the like.

Additionally, as shown in FIGS. 3 to 5 and the like, the nut 5A is displaceably held by the nut holding portion 6A. Therefore, the portions facing the members 61 and 62 of the nut holding portion 6A are configured as recessed plane portions 56A and 56B that are recessed so as to allow the rising surface portion 63 in the member 61 or 62 to enter and be present in the recessed plane portions.

As shown in FIGS. 4, 5, and the like, the recessed plane portions 56A and 56B in Exemplary Embodiment 1 are provided as concave portions formed by cutting two side surface portions among four side surface portions of the body 51 consisting of a substantially square shape as a planar shape and a required thickness d into a rectangular parallelepiped shape with a required recess width L1 and a required recess amount toward the screw hole 52. Additionally, the recessed plane portions 56A and 56B are formed in a shape having a planar bottom surface portion 57 facing the members 61 and 62 of the nut holding portion 6A and facing surface portions 58a and 58b consisting of a pair of wall surfaces facing each other and reaching the bottom surface portion 57.

As shown in FIGS. 5A and 5B, in the recessed plane portions 56A and 56B, the nut 5A needs to be disposed between the members 61 and 62 of the nut holding portion 6A. Therefore, a spacing Ls between the members 61 and 62 is a dimension slightly narrower than the spacing S1 between the members 61 and 62 the nut holding portion 6A (Ls<S1).

Additionally, the recess width (spacing between the facing surface portions 58a and 58b) L1 of the recessed plane portions 56A and 56B is a dimension larger than the width W2 of the members 61 and 62 of the nut holding portion 6A (L1>W2).

The recess width L1 of the recessed plane portions 56A and 56B is set to a dimension larger than the width W2 of the members 61 and 62 by a required amount so that required gaps E1 and E2 can be obtained between the facing surface portions 58a and 58b and the members 61 and 62 depending on a distance required to displace the nut 5A in the directions of the arrows X1 and X2.

In addition, as shown in FIGS. 4 and 5, in the nut 5A in Exemplary Embodiment 1, surplus recessed plane portions 56C and 56D consisting of the same configuration as the recessed plane portions 56A and 56B are provided on the remaining two side surface portions of the four side surface portions of the body 51.

Accordingly, the nut 5A can be attached by disposing the recessed plane portions 56C and 56D so as to face the members 61 and 62 of the nut holding portion 6A. For this reason, in the nut 5A, the attachment work of the nut 5A to the nut holding portion 6A is easily performed as compared to a case where the surplus recessed plane portions 56C and 56D are not provided.

Additionally, the screw through-hole 25 in the first member 2 used in the screw fastening structure 1A is formed as a substantially rectangular non-screw hole (through-hole in which no screw thread is formed) as shown in FIG. 4. The size of each side of the substantially rectangular shape of the screw through-hole 25 is a dimension larger than an outer diameter (the outer diameter of the screw thread 42) Da of the body portion 41 of the screw 4.

Additionally, the screw through-holes 35 and 36 in the second member 3 used in the screw fastening structure 1A are formed of, for example, round holes. Additionally, as shown in FIG. 2, the screw through-holes 35 and 36 are formed as non-screw holes consisting of a dimension (D1, D2>Da) in which the diameters D1 and D2 thereof are larger than the outer diameter (the outer diameter of the screw thread 42) Da of the body portion 41 of the screw 4.

The screw hole 52 of the nut 5A is formed such that the diameter (inner diameter) thereof is a dimension in which the outer diameter Da of the body portion 41 of the screw 4 and the screw threads match each other.

### Attachment of Nut to Nut Holding Portion

Then, in the screw fastening structure 1A, the nut 5A is attached so as to be held by the nut holding portion 6A as illustrated in FIG. 3 and the like.

In this case, as illustrated in FIG. 4, the attachment is performed, for example, by pushing in the nut 5A from the upper sides of the members 61 and 62 of the nut holding portion 6A.

In this case, the nut 5A touches and is pushed into the bent surface portions 64 of the members 61 and 62. Accordingly, in the nut holding portion 6A, the members 61 and 62 are temporarily elastically deformed, and a spacing S2 between the bent surface portions 64 is widened.

As a result, as shown in FIGS. 3 and 5, the nut 5A passes between the bent surface portions 64 of the members 61 and 62, and then is sandwiched between the rising surface portions 63. In this case, the rising surface portions 63 of the members 61 and 62 enter the recessed plane portions 56A and 56B of the nut 5A and face the bottom surface portions 57 of the recessed plane portions 56A and 56B, and the bent surface portions 64 thereof approach and face a portion (surface) between the recessed plane surfaces 56A and 56B in the nut 5A.

In this way, in the screw fastening structure 1A, the attachment work in a case where the nut 5A is held by the nut holding portion 6A is easily performed compared to a case where the members 61 and 62 are not elastically deformed.

Additionally, in the screw fastening structure 1A, the nut 5A is held by the nut holding portion 6A as to be displaceable in the directions of the arrows X1 and X2 in the recessed portion 22 of the first member 2.

Specifically, the nut 5A in the screw fastening structure 1A can be displaced in the directions of the arrows X1 and X2 by a difference (E1+E2) of the recess width L1 of the recessed plane portions 56A and 56B from the width W2 of the rising surface portion 63 of the members 61 or 62. Additionally, in this case, the nut 5A is such that the displacement movement of the nut 5A is stopped as the facing surface portions 58a and 58b in the recessed plane portions 56A and 56B come into contact with the rising surface portions 63 of the members 61 and 62.

In Exemplary Embodiment 1, the direction indicated by the arrow X is assumed to be, for example, an up-down direction, but may be a direction other than this direction (horizontal direction, oblique direction, or the like).

### Screw Fastening by Screw Fastening Structure

Then, the screw fastening by the screw fastening structure 1A is performed as follows.

That is, in the screw fastening structure 1A, first, the second member 3 is held in a state of being pressed against the surface portion 22d of the recessed portion 22 of the first member 2.

In this case, in a case where the second member 3 is pressed against the surface portion 22d of the recessed portion 22 of the first member 2, the second member 3 is brought into a positioned state by positioning units such as an uneven fitting structure, at a fastening position preset on the surface portion 22d.

Subsequently, in the screw fastening structure 1A, as shown in FIG. 6, after the screw 4 is inserted into and penetrated through the screw through-holes 35 and 36 of the second member 3, the screw 4 is passed through the screw through-hole 25 in the first member 2 and inserted toward the screw hole 52 of the nut 5A.

In this case, between the first member 2 and the second member 3, there is a positional deviation caused by a tolerance or the like between the position (a movement line J1 as inserted) of a tip part of the body portion 41 of the screw 4 that has passed through the screw through-holes 35 and 36 or the screw through-holes 35 and 36 and the position (a centerline J2 of the screw hole) of the screw hole 52 of the nut 5A (strictly, there is a case where there is a positional deviation in the direction indicated by the arrow X). Even in this case, in the screw fastening structure 1A, the position of the screw hole 52 may be finely adjusted by displacing the nut 5A in any of the directions indicated by the arrows X1 and X2 in the nut holding portion 6A.

As a result, in the screw fastening structure 1A, the screw 4 is normally fitted and screwed into the screw hole 52 of the nut 5A displaced in any of the directions indicated by the arrows X1 and X2. Additionally, in the screw fastening structure 1A, the second member 3 is screw-fastened to the first member 2 by formally fastening the screw 4 to the screw hole 52 of the nut 5A.

Therefore, according to the screw fastening structure 1A, the nut 5A is held by the nut holding portion 6A so as to be displaceable in the screw fastening structure in which the nut 5A is attached to the first member 2 in advance. Thus, even in a case where there is a positional deviation between the screw through-holes 35 and 36 of the second member 3 on a side on which the screw 4 is inserted and (the screw hole 52 of) the nut 5A, the nut 5A may be displaced by a required amount to eliminate the positional deviation. As a result, in the screw fastening structure 1A, the screw 4 may be screwed into the screw hole 52 of the nut 5A without any trouble, and the first member 2 and the second member 3 may be screw-fastened to each other.

Additionally, in the screw fastening structure 1A, it is necessary to provide the nut 5A in the recessed portion 22 that is the thin-walled portion of the first member 2. In such a situation, instead of the nut 5A, even in a case where a configuration is adopted in which the screw 4 is screwed into a screw hole that has been threaded (formation of a female screw) by performing the extrusion processing on the recessed portion 22 that is the thin-walled portion, the threading cannot be performed.

For this reason, in the screw fastening structure 1A, the screw fastening may be performed even in a case where the extrusion processing is performed on the thin-walled portion in this way and the threading cannot be performed.

Incidentally, the screw fastening structure 1A is attached such that the nut 5A is displaceably held by the nut holding portion 6A without welding and fixing the nut 5A to the recessed portion 22 of the first member 2.

For this reason, in the screw fastening structure 1A, the position of the screw hole 52 may be finely adjusted by displacing the nut 5A.

Additionally, in a case where the nut 5A is welded and fixed, a jig for determining the welding position of the nut is required, and a relatively large cost is required for preparing the jig and performing the welding. In this respect, in the screw fastening structure 1A, the jig for determining the welding position of the nut as in the case of welding and fixing the nut 5A becomes unnecessary, and the welding itself also becomes unnecessary. As a result, the cost for the jig and the welding may also be made unnecessary.

### Exemplary Embodiment 2

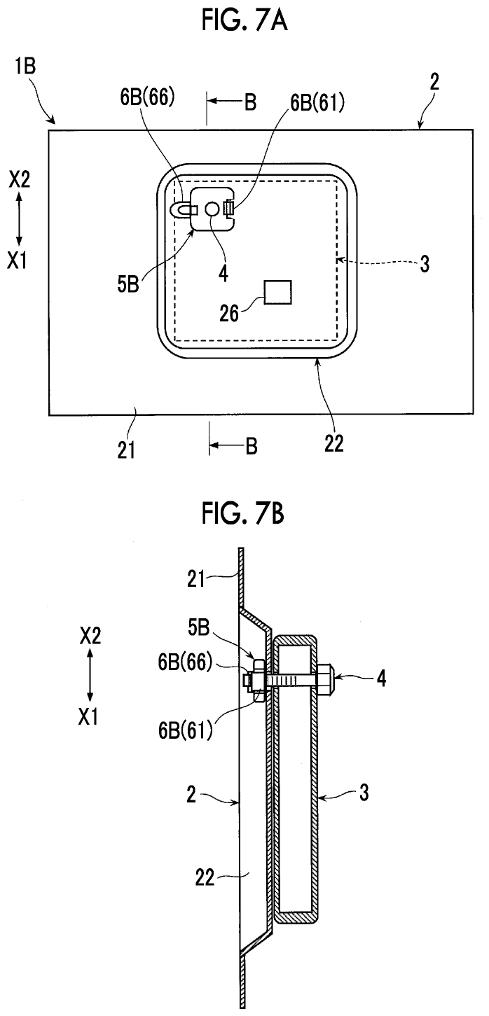

FIGS. 7A and 7B are a plan view and a partial cross-sectional view showing a screw fastening structure 1B according to Exemplary Embodiment 2 of the present invention.

The screw fastening structure 1B is different in that a nut 5B and a nut holding portion 6B are applied instead of the nut 5A and the nut holding portion 6A, but except for that, the screw fastening structure 1B consists of the same configuration as the screw fastening structure 1A according to Exemplary Embodiment 1.

For this reason, as shown in FIGS. 7A and 7B, the screw fastening structure 1B includes the first member 2, the second member 3, the screw 4, the nut 5B, and the nut holding portion 6B.

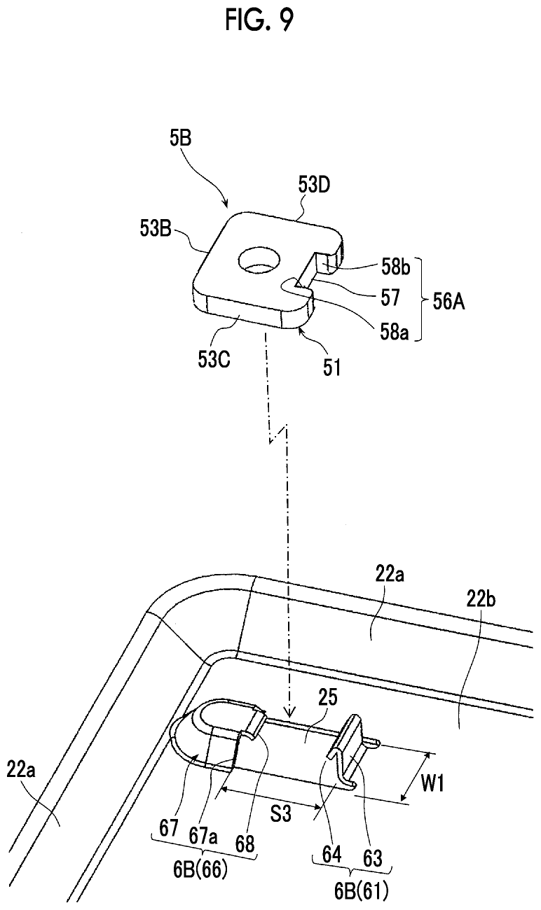

The nut 5B in Exemplary Embodiment 2 is not provided with the recessed plane portions 56B, 56C, and 56D of the nut 5A in Exemplary Embodiment 1, and as shown in FIG. 9 and the like, the nut 5B is different in that original three side surface portions of the body 51 are configured as the plane portions 53B, 53C, and 53D. However, except for that, the nut 5B consists of the same configuration as the nut 5A in Exemplary Embodiment 1.

Additionally, in the nut 5B, as shown in FIG. 9 and the like, the recessed plane portion 56A in Exemplary Embodiment 1 is similarly provided on one of the original side surface portions of the body 51.

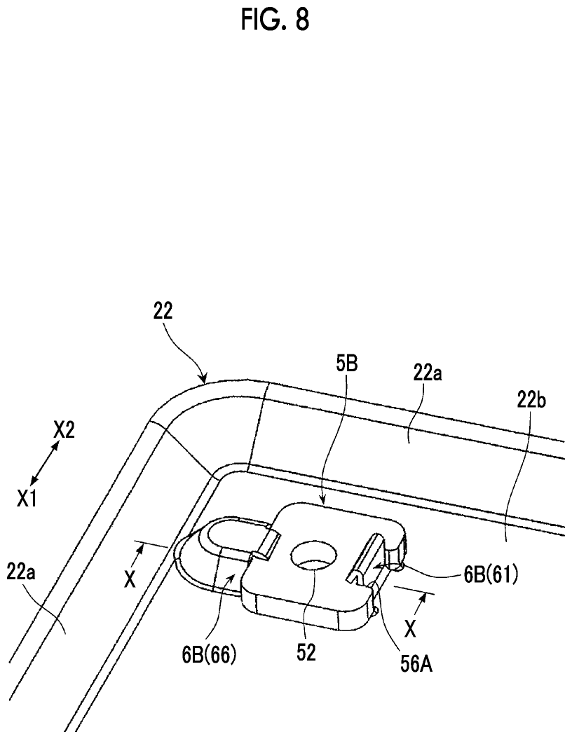

As shown in FIGS. 7A and 7B, FIG. 8, and the like, the nut holding portion 6B in Exemplary Embodiment 1 is configured as a holding unit that holds the nut 5B so as to reciprocate and displace in one direction (X direction) indicated by an arrow X1 or X2.

Additionally, as shown in FIGS. 8 and 9, and the like, the nut holding portion 6B is configured by a pair of members 61 and 66 disposed so as to face each other across the nut 5B, on a surface portion 22b which is a bottom surface of the recessed portion 22 of the first member 2 on the recessed side.

As shown in FIGS. 8 and 9, the member 61 of the pair of members 61 and 66 faces the bottom surface portion 57 of the recessed plane portion 56A of the nut 5B, similar to the member 61 in Exemplary Embodiment 1, and is formed as a member consisting of a shape having the rising surface portion 63 and the bent surface portion 64.

Additionally, the member 61 is configured as a member that can be elastically deformed.

The member 61 regulates a range in which the nut 5B can be displaced and moved in the direction of the arrow X by the facing surface portions 58a and 58b.

One member 66 is formed as a member consisting of a shape having a raised portion 67 raised from the surface portion 22b of the recessed portion 22 and a protruding portion 68 protruding from a top portion of the raised portion 67 toward the member 61 side. The raised portion 67 has an end part 67a that faces the plane portion 53B of the nut 5B. The end part 67a is formed as an inclined part that rises by being inclined so as to gradually approach the inclined part from the surface portion 22b of the recessed portion 22.

Additionally, the member 66 is configured as a member that is not elastically deformed.

The member 66 is made, for example, by raising a portion, which becomes one of two predetermined cut pieces obtained by cutting a part of the recessed portion 22 in a case where the member 61 is made, without cutting, and raising the left portion through embossing, deep-drawing, or the like, in a required shape.

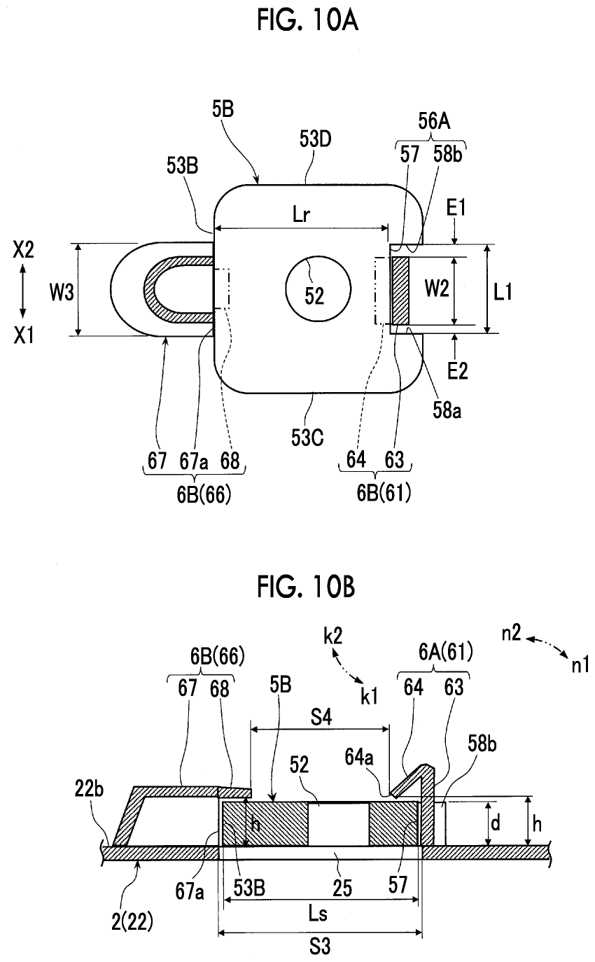

Moreover, as shown in FIGS. 10A and 10B, the member 66 is formed to have a dimension in which a spacing W3 between the portions of the end parts 67a of the raised portion 67 closest to the surface portion 22b of the recessed portion 22 is slightly larger than the width W1 of the screw through-hole 25.

The end part 67a of the raised portion 67 is formed to have a dimension in which a spacing S3 from the rising surface portion 63 of one member 61 is slightly larger than a spacing Lr between the bottom surface portion 57 and the plane portion 53B of the recessed plane portion 56A in the nut 5B.

Additionally, as shown in FIGS. 10A and 10B, the member 66 is formed such that the protruding portion 68 is a portion having a required height (gap) h from the surface portion 22b of the recessed portion 22. This height h is the same as the height h of the bent tip 64a of the bent surface portion 64 in one member 61.

The protruding portion 68 is formed to have a dimension in which the spacing S3 between the bent surface portion 64 of one member 61 at a protruding tip thereof is narrower than the spacing Lr between the bottom surface portion 57 of the recessed plane portion 56A and the plane portion 53B in the nut 5B.

### Attachment of Nut to Nut Holding Portion

Then, in the screw fastening structure 1B, the nut 5B is attached so as to be held by the nut holding portion 6B as illustrated in FIGS. 7A and 7B and the like.

In this case, as illustrated in FIG. 9, the attachment is performed, for example, by pushing in the nut 5B from the upper side of the member 61 or 66 of the nut holding portion 6B.

In this case, the nut 5B touches and is pushed into the bent surface portion 64 of the member 61 and the protruding portion 68 of the member 66. Accordingly, in the nut holding portion 6B, the member 61 is temporarily elastically deformed, and the spacing S3 from the member 66 is temporarily widened.

As a result, the nut 5B passes between the bent surface portion 64 of the member 61 and the protruding portion 68 of the member 66, and then, as shown in FIG. 8, is brought into a state of being sandwiched between the rising surface portion 63 of the member 61 and the end part 67a of the raised portion 67 of the member 66.

in this case, the rising surface portion 63 of the member 61 enters the recessed plane portion 56A of the nut 5B and faces the bottom surface portion 57 of the recessed plane portion 56A. Additionally, in this case, the member 66 is brought into a state where the end part 67a of the raised portion 67 faces the plane portion 53B of the nut 5B. Moreover, in this case, the bent surface portion 64 of the member 61 and the protruding portion 68 of the member 66 are brought into a state of approaching the surface of the nut 5B and facing the surface.

In this way, in the screw fastening structure 1B, the attachment work in a case where the nut 5B is held by the nut holding portion 6B is easily performed compared to a case where the member 61 is not elastically deformed.

Additionally, in the screw fastening structure 1B, the nut 5B is held by the nut holding portion 6B so as to be displaceable in the directions of the arrows X1 and X2 in the recessed portion 22 of the first member 2.

Specifically, the nut 5B in the screw fastening structure 1B can be displaced in the directions of the arrows X1 and X2 by a difference (E1+E2) of the recess width L1 of the recessed plane portion 56A from the width W2 of the rising surface portion 63 of the member 61. Additionally, in this case, the nut 5B is such that the displacement movement of the nut 5B is stopped as the facing surface portions 58a and 58b of the recessed plane portions 56A come into contact with the rising surface portion 63 of the member 61.

### Screw Fastening by Screw Fastening Structure

Then, the screw fastening by the screw fastening structure 1B is performed as follows.

That is, in the screw fastening structure 1B, similar to the case of the screw fastening structure 1A according to Exemplary Embodiment 1, first, the second member 3 is held in a state of being pressed against the surface portion 22d of the recessed portion 22 of the first member 2.

Subsequently, in the screw fastening structure 1B, after the screw 4 is inserted into and penetrated through the screw through-holes 35 and 36 of the second member 3, the screw 4 is passed through the screw through-hole 25 in the first member 2 and inserted toward the screw hole 52 of the nut 5B.

In this case, also in the screw fastening structure 1B, the position of the screw hole 52 may be finely adjusted by displacing the nut 5B in any of the directions indicated by the arrows X1 and X2 in the nut holding portion 6B.

Accordingly, also in the screw fastening structure 1B, the screw 4 is normally fitted and screwed into the screw hole 52 of the nut 5B displaced in any of the directions indicated by the arrows X1 and X2. Additionally, also in the screw fastening structure 1B, the second member 3 is screw-fastened to the first member 2 by formally fastening the screw 4 to the screw hole 52 of the nut 5B.

Therefore, according to the screw fastening structure 1B, the nut 5B is displaceably held by the nut holding portion 6B in the screw fastening structure in which the nut 5B is attached to the first member 2 in advance. Thus, even in a case where there is a positional deviation between the screw through-holes 35 and 36 of the second member 3 on a side on which the screw 4 is inserted into (the screw hole 52 of) the nut 5B, the nut 5B may be displaced by a required amount to eliminate the positional deviation. As a result, also in the screw fastening structure 1B, the screw 4 may be screwed into the screw hole 52 of the nut 5B without any trouble, and the first member 2 and the second member 3 may be screw-fastened to each other.

### Exemplary Embodiment 3

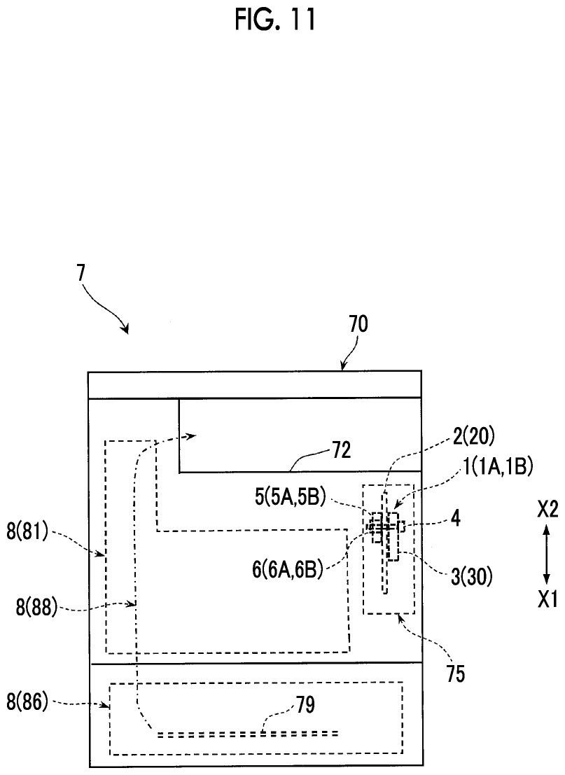

FIG. 11 is a schematic view of a device 7 comprising the screw fastening structure 1 according to Exemplary Embodiment 3 of the present invention.

The device 7 comprising the screw fastening structure 1 has the housing 70, the image forming unit 81 as an example of the operating unit 8, the medium supply unit 86 of the recording medium 79, and the medium transport unit 88 are disposed in the housing 70, and the control unit 75 that controls the operation of the operating unit 8 and the like is disposed in the housing.

For this reason, the device 7 according to Exemplary Embodiment 3 is configured as an image forming device that forms an image, based on image information input from the outside, on the recording medium 79.

The image forming unit 81 is a portion that actually forms an image on the recording medium 79. The image forming unit 81 is configured with equipment corresponding to a required image forming method such as an electrophotographic method, an ink jet method, an electrostatic recording method, a heat sensitive recording method, and related equipment.

The medium supply unit 86 is a portion that accommodates and supplies the recording medium 79 used in the image forming unit 81. The medium supply unit 86 is configured by an accommodating body that accommodates a plurality of recording media 79, a delivery device that delivers the recording medium 79 accommodated in the accommodating body to the medium transport unit 88, and the like. The recording medium 79 may be any medium as long as an image can be formed thereon by the image forming unit 81 and the medium can be transported by the medium transport unit 88.

The medium transport unit 88 is a portion that transports the recording medium 79 delivered from the medium supply unit 86 to the image forming unit 81, and transports the recording medium 79 on which the image is formed by the image forming unit 81 so as to be ejected to the medium ejection unit 72 provided in the housing 70. The medium transport unit 88 is configured by a plurality of transport rolls that transports the recording medium 79, a guide member that transports and guides the recording medium 79, and the like.

The control unit 75 is configured with equipment necessary for control operation (including equipment necessary for detection). The control unit 75 in Exemplary Embodiment 3 includes, for example, a support frame 20 as an example of the first member 2, an electronic component housing 30 as an example of the second member 3 screw-fastened to the support frame 20, and the like.

Additionally, a structure in which the nut 5 is attached to the support frame 20 in advance and the screw fastening is performed with the screw 4 and the nut 5, that is, the screw fastening structure 1 is applied to a part or all of the support frame 20 and the electronic component housing 30.

Then, in the device 7 consisting of the image forming device, a part or all of the screw fastening structure 1 in the control unit 75 is constituted by the screw fastening structure 1A (refer to FIGS. 1A and 1B or the like) or according to Exemplary Embodiment 1 or the screw fastening structure 1B (refer to FIGS. 7A and 7B or the like) according to Exemplary Embodiment 2.

By adopting the screw fastening structure 1A or the screw fastening structure 1B, the support frame 20 and the electronic component housing 30 in the control unit 75 include the following configurations.

That is, the support frame 20 is provided with a screw through-hole (not shown) through which the screw 4 is passed, and the nut 5 (5A, 5B) is held displaceably in the direction of the arrow X by the nut holding portion 6 (6A, 6B) and attached. Additionally, the electronic component housing 30 is provided with a screw through-hole (not shown) through which the screw 4 is passed.

Accordingly, in the control unit 75, the electronic component housing 30 is screw-fastened to the support frame 20 by the screw fastening structure 1A or the screw fastening structure 1B.

Additionally, in the device 7 consisting of the image forming device, in a case where the electronic component housing 30 is screw-fastened to the support frame 20, a positional deviation caused by a tolerance or the like may be present between the position of a screw through-hole or the tip part of the screw 4 passed through the screw through-hole thereof and the position of the screw hole of the nut 5 between the support frame 20 and the electronic component housing 30 (strictly, a case where there is a positional deviation in the direction indicated by the arrow X). Even in this case, since the screw fastening structure 1A comprises the screw fastening structure 1A or 1B, the position of the screw hole of the nut 5 may be finely adjusted by displacing the nut 5 in any of the directions indicated by the arrows X1 and X2 in the nut holding portion 6.

As a result, in the control unit 75 that has adopted the screw fastening structure 1A or the screw fastening structure 1B, the screw 4 is normally fitted and screwed into the screw hole of the nut 5 displaced in any of the directions indicated by the arrows X1 and X2. Additionally, in the control unit 75, the electronic component housing 30 is screw-fastened to the support frame 20 by formally fastening the screw 4 to the screw hole of the nut 5.

Therefore, according to the device 7 that has adopted the screw fastening structure 1A or the screw fastening structure 1B, the nut 5 is held by the nut holding portion 6 so as to be displaceable in the screw fastening structure LA or the screw fastening structure 1B. Thus, even in a case where there is a positional deviation between the screw through-hole of the electronic component housing 30 on a side on which the screw 4 is inserted into (the screw hole of) the nut, the nut 5 may be displaced by a required amount to eliminate the positional deviation. As a result, in the control unit 75 of the device 7, the screw 4 may be screwed into the screw hole of the nut 5 without any trouble, and the support frame 20 and the electronic component housing 30 may be screw-fastened to each other.

### Others

The present invention has shown representative configuration examples according to Exemplary Embodiment 1 to Exemplary Embodiment 3 (including the modification examples thereof), but the present invention is not limited to these configurations, and some of the configurations may be changed as necessary.

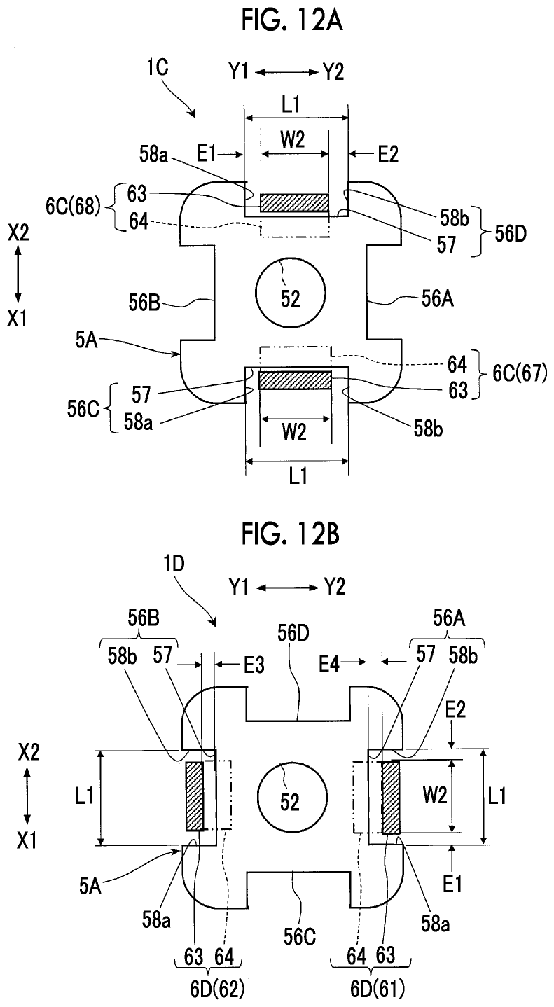

For example, as in a screw fastening structure 1C exemplified as Modification Example 1 in FIG. 12A, the screw fastening structure 1 may be configured such that a pair of members 67 and 68 in a nut holding portion 6C is disposed in and attached to the recessed plane portions 56C and 56D of the nut 5A so as to hold the nut 5A displaceably with respect to the directions Y1 and Y2 substantially orthogonal to the direction of the arrow X.

In this case, the nut 5A consists of the same configuration as the nut 5A in Exemplary Embodiment 1. Additionally, the pair of members 67 and 68 in the nut holding portion 6C consists of the same configuration as the pair of members 61 and 62 in the nut holding portion 6A in Exemplary Embodiment 1.

In addition, in the screw fastening structure 1C of Modification Example 1, the nut 5B and the nut holding portion 6B in Exemplary Embodiment 2 may be applied and configured as the nut 5 and the nut holding portion 6.

Additionally, as in a screw fastening structure 1D exemplified as Modification Example 2 in FIG. 12B, the screw fastening structure 1 may be configured such that the pair of members 61 and 62 in the nut holding portion 6D is disposed by required spacings E3 and E4 from (the bottom surface portions 57 of) the recessed plane portions 56A and 56B of the nut 5A in Exemplary Embodiment 1 to hold the nut 5A displaceably in both the directions indicated by the arrows X1 and X2 and the directions Y1 and Y2 substantially orthogonal to the arrow X.

In this case, the pair of members 61 and 62 in the nut holding portion 6D consists of the same configuration as the pair of members 61 and 62 in the nut holding portion 6A in Exemplary Embodiment 1, except that the disposition positions are different from each other. Additionally, the pair of members 61 and 62 in the nut holding portion 6D is set with disposition and dimensions such that the nut 5A does not fall out of the holding in a case where the nut 5A has moved in both the direction of that arrow X and the direction of the arrow Y.

In addition, in the screw fastening structure 1D of Modification Example 2, the nut 5B and the nut holding portion 6B in Exemplary Embodiment 2 may be applied and configured as the nut 5 and the nut holding portion 6.

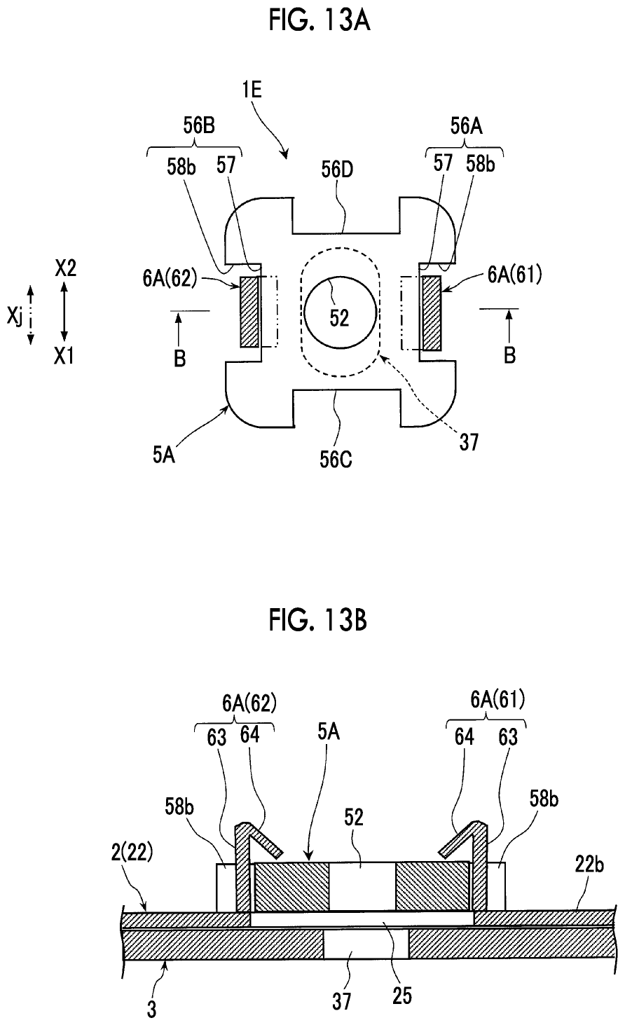

Additionally, as in a screw fastening structure 1E exemplified as Modification Example 3 in FIGS. 13A and 13B, the screw fastening structure 1 may be configured such that, as long as an elongated hole that is long in one direction (a direction that becomes a longitudinal direction of the elongated hole) is provided as the screw through-hole 37 in the second member 3 so as to hold the nut 5A displaceably in a longitudinal direction Xj in the elongated hole of the screw through-hole 37 with respect to the nut holding portion 6A.

In Modification Example 3, the direction of the arrow X at which the nut holding portion 6A displaces the nut 5A is a direction parallel to the longitudinal direction Xj in the elongated hole of the screw through-hole 37.

In addition, in the screw fastening structure 1E of Modification Example 3, the nut 5B and the nut holding portion 6B in Exemplary Embodiment 2 may be applied and configured as the nut 5 and the nut holding portion 6. In that case, the nut holding portion 6B may be configured to hold the nut 5B displaceably in the longitudinal direction Xj of the elongated hole of the screw through-hole 37 provided in the second member 3.

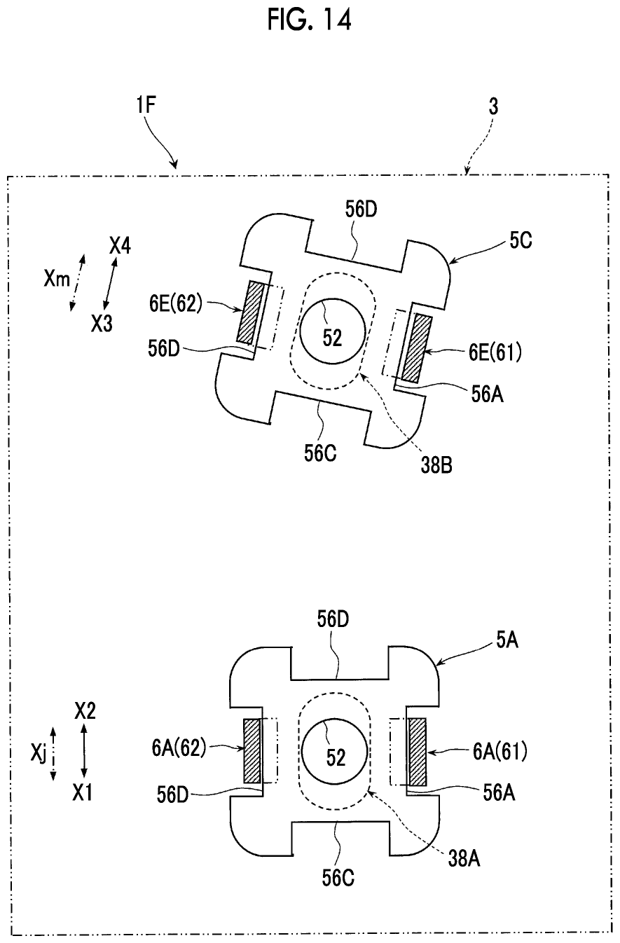

Additionally, as in a screw fastening structure 1F exemplified as Modification Example 4 in FIG. 14, the screw fastening structure 1 may be configured such that, as long as nuts 5A and 5C and nut holding portions 6A and 6E are respectively disposed at a plurality of points of the first member 2 in which the nut 5 is disposed, the directions (the directions indicated by the arrows X3 and X4) in which the nuts 5C are displaced are made different from the direction (the directions indicated by the arrows X1 and X2) in which the nut 5A of the other nut holding portion 6A is displaced, with respect to the nut holding portion 6E of at least a part (one in Modification Example 4) of the plurality of nut holding portions 6A and 6E).

In this case, the directions indicated by the arrows X3 and X4 in the screw fastening structure 1F are directions inclined by a required angle with respect to the directions indicated by the arrows X1 and X2 in the same plane portion where the nut 5 of the first member 2 is to be disposed. Additionally, the nut 5C in the screw fastening structure 1F has a different disposition posture in accordance with the displacement direction, but except for that, the nut 5C consists of the same configuration as the nut 5A in Exemplary Embodiment 1. Additionally, the nut holding portion 6E in the screw fastening structure 1F is different in terms of the disposition posture of the pair of members 61 and 62, but except for that, the nut holding portion 6E consists of the same configuration as the nut holding portion 6A in Exemplary Embodiment 1.

Additionally, in the screw fastening structure 1F, the direction (the directions indicated by arrows X1 and X2) in which the nut 5A of the nut holding portion 6A is displaced and the direction (the directions indicated by arrows X3 and X4) in which the nut 5C of the nut holding portion 6E is displaced can be set optionally. However, regarding each displacement direction, for example, as long as the second member 3 is provided with a screw through-hole 38A or 38B as an elongated hole, the direction may be set in accordance with the direction parallel to each longitudinal direction Xj or Xm of the elongated hole of the screw through-hole 38A or 38B.

In addition, the screw fastening structure 1F of the Modification Example 4 has been described assuming the same plane portion as the portion of the first member 2 in which the plurality of nuts 5 and the nut holding portion 6 are disposed. However, regarding the disposition portion, mutually different portions may be adopted, not on the same plane portion. In that case, the plurality of nuts 5 and the nut holding portions 6 are appropriately distributed and disposed in different portions.

In addition, in the screw fastening structure 1 of the present invention, the nut 5 and the nut holding portion 6 may be disposed on the side of the second member 3. The first member 2 or the second member 3 in which the nut 5 and the nut holding portion 6 are not disposed may be provided with a screw hole through which the screw 4 passes instead of the screw through-hole.

Additionally, the screw fastening structure 1 may be configured such that another member is interposed between the first member 2 and the second member 3 to screw-fasten the members to each other.

Moreover, the forms of the first member 2 and the second member 3 are not limited to forms exemplified in each exemplary embodiment, and other forms may be adopted as long as the screw fastening structure 1 can be applied.

The pair of members 61 and 62 in the nut holding portion 6 may be made of members different from the first member 2 or the second member 3 to which the members 61 and 62 are provided, and then may be completed by fixing (anchoring) to a position where the first member 2 or the second member 3 is to be disposed.

The shape of the nut 5 and the shape of the pair of members 61 and 62 in the nut holding portion 6 are not limited to the shapes exemplified in the above-described examples and modification examples, and may be other shapes. The nut 5A in Exemplary Embodiment 1 may be omitted without providing the recessed plane portions 56C and 56D in which the nut holding portion 6A is not disposed.

The device 7 including the screw fastening structure 1 is not limited to the image forming device, and may be any type of device as long as the screw fastening structure 1 of the present invention can be effectively applied thereto.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A screw fastening structure comprising:
a nut; and
a nut holding portion that holds the nut displaceably in at least one direction, which are provided on at least one of a first member and a second member screw-fastened to each other with a screw and the nut.

2. A screw fastening structure comprising:
a first member provided with a screw through-hole;
a second member provided with a screw through-hole;
a screw to be inserted from the screw through-hole of the first member or the second member;
a nut that is disposed on the second member or the first member on a side opposite to a side where the screw is inserted; and
a nut holding portion that is provided on a portion having the screw through-hole, of the second member or the first member on the opposite side and holds the nut in a displaceable state in at least one direction.

3. The screw fastening structure according to claim 1,
wherein the nut holding portion is a pair of members that is disposed so as to face each other across the nut, and at least one of the pair of members is configured as a member that is elastically deformable.

4. The screw fastening structure according to claim 2,
wherein the nut holding portion is a pair of members that is disposed so as to face each other across the nut, and at least one of the pair of members is configured as a member that is elastically deformable.

5. The screw fastening structure according to claim 1,
wherein the first member or the second member on a side where the screw is inserted is provided with an elongated hole, which is long in one direction, as the screw through-hole, and
the nut holding portion is configured to hold the nut displaceably in a longitudinal direction of the elongated hole.

6. The screw fastening structure according to claim 2,
wherein the first member or the second member on a side where the screw is inserted is provided with an elongated hole, which is long in one direction, as the screw through-hole, and
the nut holding portion is configured to hold the nut displaceably in a longitudinal direction of the elongated hole.

7. The screw fastening structure according to claim 1,
wherein the nut holding portion is configured as a member formed by cutting out a part of the first member or the second member on which the nut is disposed.

8. The screw fastening structure according to claim 2,
wherein the nut holding portion is configured as a member formed by cutting out a part of the first member or the second member on which the nut is disposed.

9. The screw fastening structure according to claim 1,
wherein a portion of the nut that faces the nut holding portion is configured as a plane portion.

10. The screw fastening structure according to claim 2,
wherein a portion of the nut that faces the nut holding portion is configured as a plane portion.

11. The screw fastening structure according to claim 9,
wherein at least one portion of the nut that faces the nut holding portion is configured as a recessed plane portion which is recessed so as to allow the nut holding portion to enter and be present in the recessed plane portion.

12. The screw fastening structure according to claim 10,
wherein at least one portion of the nut that faces the nut holding portion is configured as a recessed plane portion which is recessed so as to allow the nut holding portion to enter and be present in the recessed plane portion.

13. The screw fastening structure according to claim 1,
wherein in a case where the nut and the nut holding portion are respectively disposed at a plurality of points of the first member or the second member on which the nut is disposed,
at least some nut holding portions of the plurality of nut holding portions have a nut displacement direction different from a nut displacement direction of the other nut holding portions.

14. The screw fastening structure according to claim 2,
wherein in a case where the nut and the nut holding portion are respectively disposed at a plurality of points of the first member or the second member on which the nut is disposed,
at least some nut holding portions of the plurality of nut holding portions have a nut displacement direction different from a nut displacement direction of the other nut holding portions.

15. The screw fastening structure according to claim 1,
wherein the second member or the first member on which the nut is disposed has a portion having the screw through-hole configured as a thin-walled portion having a thickness smaller than another portion.

16. The screw fastening structure according to claim 2,
wherein the second member or the first member on which the nut is disposed has a portion having the screw through-hole configured as a thin-walled portion having a thickness smaller than another portion.

17. A device having a screw fastening structure, comprising:
a first member and a second member, which are screw-fastened to each other with a screw and a nut; and
a structure that screw-fastens the first member and the second member to each other by attaching the nut to at least one of the first member and the second member in advance,
wherein at least a part of the screw fastening structure is configured by the screw fastening structure according to claim 1.

18. A device having a screw fastening structure, comprising:
a first member and a second member, which are screw-fastened to each other with a screw and a nut; and
a structure that screw-fastens the first member and the second member to each other by attaching the nut to at least one of the first member and the second member in advance,
wherein at least a part of the screw fastening structure is configured by the screw fastening structure according to claim 2.

19. A device having a screw fastening structure, comprising:
a first member and a second member, which are screw-fastened to each other with a screw and a nut; and
a structure that screw-fastens the first member and the second member to each other by attaching the nut to at least one of the first member and the second member in advance,
wherein at least a part of the screw fastening structure is configured by the screw fastening structure according to claim 3.

20. A device having a screw fastening structure, comprising:
a first member and a second member, which are screw-fastened to each other with a screw and a nut; and
a structure that screw-fastens the first member and the second member to each other by attaching the nut to at least one of the first member and the second member in advance,
wherein at least a part of the screw fastening structure is configured by the screw fastening structure according to claim 4.
